(19) United States
(12) Patent Application Publication
(10) Pub. No.: US 2022/0413772 A1
(43) Pub. Date: Dec. 29, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/822,805

(22) Filed: Aug. 29, 2022

Related U.S. Application Data
(63) Continuation of application No. PCT/JP2020/038129, filed on Oct. 8, 2020.

(30) Foreign Application Priority Data
Mar. 10, 2020 (JP) 2020-041408

(51) Int. Cl. G06F 3/06

(52) U.S. Cl. CPC G06F 3/0686; G06F 3/0604; G06F 3/0619; G06F 3/0659

(57) ABSTRACT

An information processing device performs control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

### CROSS-REFERENCE TO RELATED APPLICATIONS

This application is a continuation application of International Application No. PCT/JP2020/038129, filed on Oct. 8, 2020, the disclosure of which is incorporated herein by reference in its entirety. Further, this application claims priority from Japanese Patent Application No. 2020-041408, filed on Mar. 10, 2020, the disclosure of which is incorporated herein by reference in its entirety.

### BACKGROUND

### 1. Technical Field

The present disclosure relates to an information processing device, an information processing method, and an information processing program.

### 2. Description of the Related Art

A technique for managing a plurality of magnetic tapes by using a magnetic tape pool is disclosed (see JP2009-93571A). In this technique, management information of the plurality of magnetic tapes belonging to the magnetic tape pool (hereinafter, referred to as “pool management information”) is stored in an information processing device such as a server computer connected to a tape library.

### SUMMARY

However, in the technique described in JP2009-93571A, the pool management information is lost in a case where a failure occurs in the information processing device in which the pool management information is stored. In addition, the magnetic tape may be transported to a remote location for purposes such as disaster recovery and data exchange with respect to other systems, because of the portability thereof. Therefore, it is preferable that the pool management information can be recovered from the magnetic tape.

The present disclosure has been made in view of the above circumstances, and an object thereof is to provide an information processing device, an information processing method, and an information processing program capable of recovering management information of a magnetic tape pool to which a magnetic tape belongs, from the magnetic tape.

According to the present disclosure, there is provided an information processing device comprising: at least one processor, in which the processor performs control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

In the information processing device of the present disclosure, the processor may perform, in a case where a new magnetic tape is added to the magnetic tape pool, control to record identification information of a predetermined first number of magnetic tapes of at least a part of a magnetic tape group already belonging to the magnetic tape pool, on the new magnetic tape or on the recording medium provided in a magnetic tape cartridge including the new magnetic tape.

Further, in the information processing device of the present disclosure, the processor may perform control to record identification information of a magnetic tape last added to the magnetic tape pool, by a number insufficient for the first number, on the new magnetic tape or on the recording medium provided in the magnetic tape cartridge including the new magnetic tape, in a case where the number of magnetic tapes already belonging to the magnetic tape pool is less than the first number.

Further, in the information processing device of the present disclosure, the processor may further perform, for the magnetic tape belonging to the magnetic tape pool, control to record identification information of a predetermined second number of magnetic tapes added to the magnetic tape pool after the magnetic tape belonging to the magnetic tape pool, at a predetermined timing.

Further, in the information processing device of the present disclosure, the processor may further perform control to record identification information of a magnetic tape first added to the magnetic tape pool, by a number insufficient for the second number, for a magnetic tape for which the number of magnetic tapes added to the magnetic tape pool afterward is less than the second number.

Further, in the information processing device of the present disclosure, the processor may periodically perform the control.

Further, in the information processing device of the present disclosure, the number of magnetic tapes of which the identification information is recorded on the magnetic tape or the recording medium may be preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

Further, in the information processing device of the present disclosure, the processor may perform, in a case where the number of the magnetic tapes which exceeds the preset number, out of the plurality of magnetic tapes belonging to the magnetic tape pool, are taken out from a storage unit in which the magnetic tapes are stored, control to record identification information of the magnetic tapes that are taken out, on a magnetic tape that is not taken out or on the recording medium provided in a magnetic tape cartridge including the magnetic tape that is not taken out.

Further, in the information processing device of the present disclosure, the processor may perform control to record information regarding the magnetic tape other than the identification information, in addition to the identification information of the magnetic tape.

Further, in the information processing device of the present disclosure, the information regarding the magnetic tape may be information indicating an order in which the magnetic tape is added to the magnetic tape pool.

According to the present disclosure, there is provided an information processing method executed by a processor provided in an information processing device, the method comprising: performing control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

According to the present disclosure, there is provided an information processing program for causing a processor provided in an information processing device to execute a process comprising: performing control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

According to the present disclosure, management information of a magnetic tape pool to which the magnetic tape belongs can be recovered from the magnetic tape.

### BRIEF DESCRIPTION OF THE DRAWINGS

FIG. 1 is a block diagram showing an example of a configuration of a recording and reproducing system.

FIG. 2 is a block diagram showing an example of a configuration of a magnetic tape cartridge.

FIG. 3 is a block diagram showing an example of a configuration of a tape drive.

FIG. 4 is a block diagram showing an example of a hardware configuration of an information processing device.

FIG. 5 is a diagram showing an example of a pool management table.

FIG. 6 is a block diagram showing an example of a functional configuration of the information processing device.

FIG. 7 is a diagram illustrating processing of adding a magnetic tape cartridge to a magnetic tape pool.

FIG. 8 is a diagram illustrating processing of recording a tape ID of the magnetic tape cartridge afterward added to the magnetic tape pool.

FIG. 9 is a diagram showing an example of a recording state of the tape ID.

FIG. 10 is a diagram showing another example of the recording state of the tape ID.

FIG. 11 is a flowchart showing an example of first identification information recording processing.

FIG. 12 is a flowchart showing an example of second identification information recording processing.

FIG. 13 is a diagram illustrating recording processing of a tape ID in a case where a magnetic tape cartridge according to a modification example is taken out.

### DETAILED DESCRIPTION

Hereinafter, examples of embodiments of the technique of the present disclosure will be described in detail with reference to the drawings.

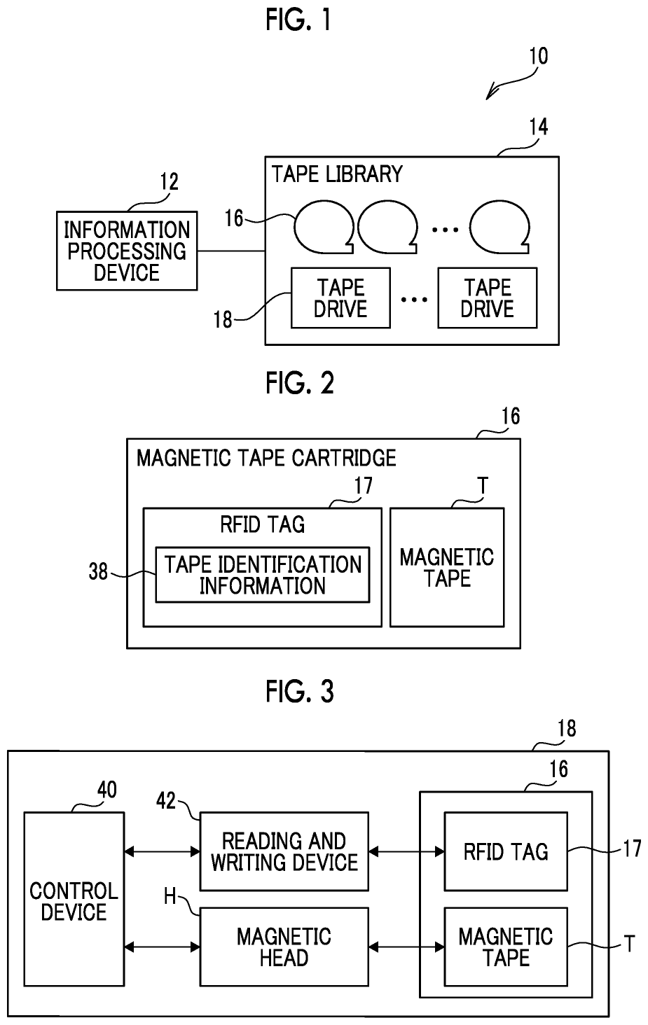

First, a configuration of a recording and reproducing system 10 according to the present embodiment will be described with reference to FIG. 1. As shown in FIG. 1, the recording and reproducing system 10 includes an information processing device 12 and a tape library 14.

The tape library 14 comprises a plurality of slots (not shown) and a plurality of tape drives 18, and a magnetic tape cartridge 16 is stored in each slot. The tape drive 18 is connected to the information processing device 12. An example of the magnetic tape cartridge 16 includes a linear tape-open (LTO) tape cartridge.

Next, a configuration of the magnetic tape cartridge 16 according to the present embodiment will be described with reference to FIG. 2. As shown in FIG. 2, the magnetic tape cartridge 16 comprises a magnetic tape T on which information is magnetically recorded, and a radio frequency identifier (RFID) tag 17 as an example of a recording medium capable of recording and reading information through wireless communication or the like in a contactless manner. Tape identification information 38 is recorded on the RFID tag 17. Although the details will be described afterward, the tape identification information 38 includes identification information of the magnetic tape cartridge 16.

Next, a configuration of the tape drive 18 according to the present embodiment will be described with reference to FIG. 3. As shown in FIG. 3, the tape drive 18 comprises a control device 40, a reading and writing device 42, and a magnetic head H. In a case where data is written or read with respect to the magnetic tape T of the magnetic tape cartridge 16, the magnetic tape cartridge 16 is stored in the tape drive 18.

The control device 40 includes a processor, such as a programmable logic device (PLD), a memory serving as a temporary storage area, a non-volatile storage unit, and the like. The control device 40 transmits and receives data to and from the information processing device 12, controls the reading and writing device 42 and the magnetic head H, and the like.

The reading and writing device 42 reads information recorded on the RFID tag 17 in a contactless manner through the control performed by the control device 40, and outputs the read information to the control device 40. In addition, the reading and writing device 42 records information on the RFID tag 17 in a contactless manner through the control performed by the control device 40. An example of the reading and writing device 42 includes an RFID reader and writer. The magnetic head H comprises a recording and reproducing element that writes and reads data with respect to the magnetic tape T.

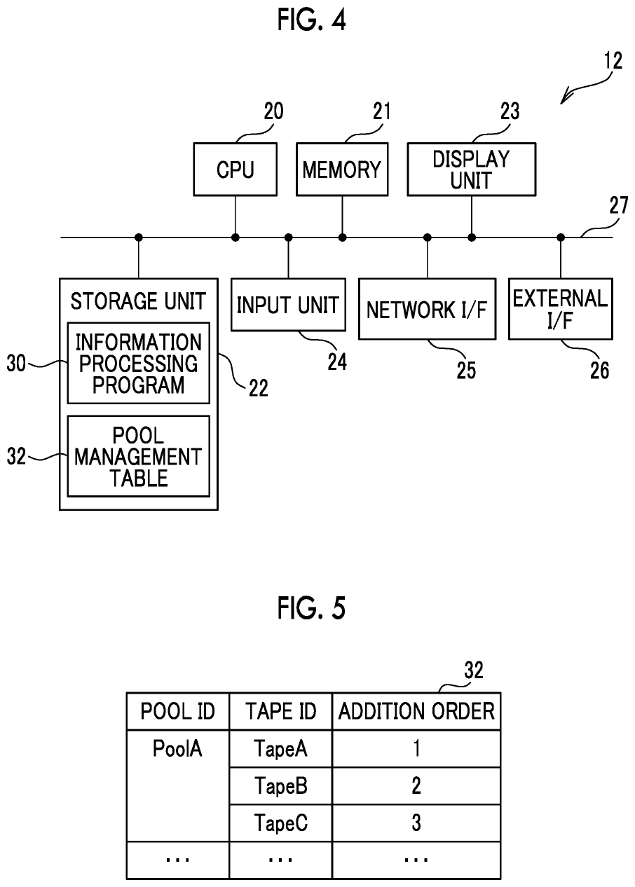

Next, the hardware configuration of the information processing device 12 according to the present embodiment will be described with reference to FIG. 4. As shown in FIG. 4, the information processing device 12 includes a central processing unit (CPU) 20, a memory 21 serving as a temporary storage area, and a nonvolatile storage unit 22. In addition, the information processing device 12 includes a display unit 23, such as a liquid crystal display, an input unit 24, such as a keyboard and a mouse, a network interface (I/F) 25 connected to a network, and an external I/F 26 to which each tape drive 18 is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 serving as a storage medium. The CPU 20 reads out the information processing program 30 from the storage unit 22 and then develops the information processing program 30 in the memory 21, and executes the developed information processing program 30. An example of the information processing device 12 includes a server computer.

Further, a pool management table 32 is stored in the storage unit 22. The recording and reproducing system 10 according to the present embodiment has a function of providing a logical volume to the information processing device 12 by using a magnetic tape pool in which magnetic tapes T of a plurality of magnetic tape cartridges 16 are grouped. The information processing device 12 writes or reads data with respect to the logical volume provided by the magnetic tape pool. With this, data is written or read with respect to the magnetic tape T of the magnetic tape cartridge 16 belonging to the magnetic tape pool. Information for managing the magnetic tape pool is recorded in the pool management table 32.

FIG. 5 shows an example of the pool management table 32. The pool management table 32 stores a pool ID as an example of the identification information of the magnetic tape pool. In addition, the pool management table 32 stores a tape ID as an example of the identification information of the magnetic tape cartridge 16 belonging to the magnetic tape pool represented by the pool ID and addition order information indicating an order in which the magnetic tape cartridge 16 is added to the magnetic tape pool (hereinafter, referred to as an “addition order”). The tape ID is an example of the identification information of the magnetic tape according to the disclosed technique. In the example of FIG. 5, an example is shown in which three magnetic tape cartridges 16 having tape IDs of “TapeA”, “TapeB”, and “TapeC” are added to a magnetic tape pool having a pool ID of “PoolA” in this order.

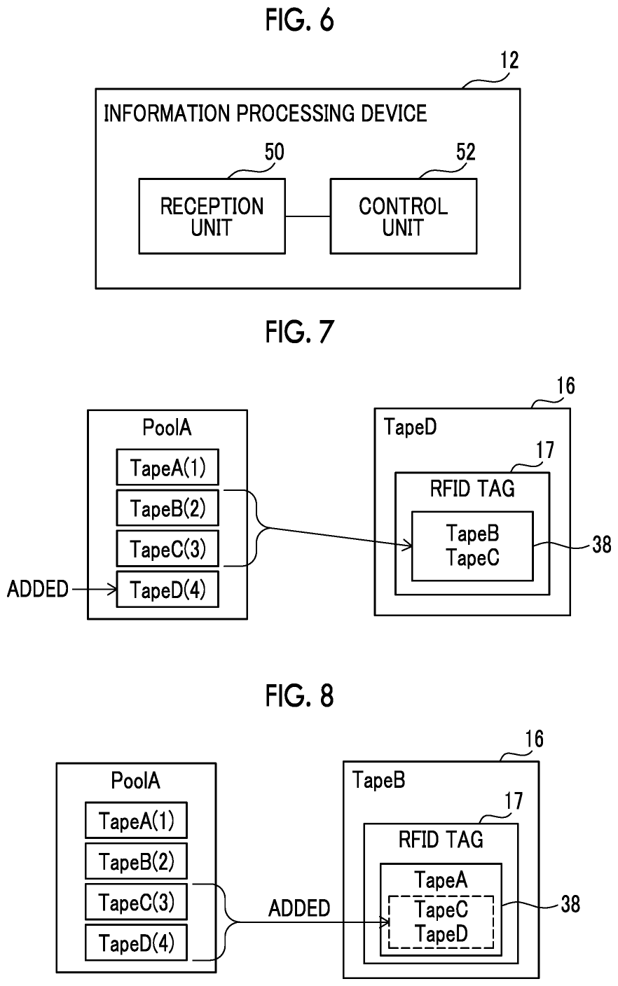

Next, a functional configuration of the information processing device 12 according to the present embodiment will be described with reference to FIG. 6. As shown in FIG. 6, the information processing device 12 includes a reception unit 50 and a control unit 52. The CPU 20 executes the information processing program 30 to function as the reception unit 50 and the control unit 52.

The reception unit 50 receives the pool ID of the magnetic tape pool to which the magnetic tape cartridge 16 is added and the tape ID of a new magnetic tape cartridge 16 to be added to the magnetic tape pool. The pool ID and the tape ID are input by a user, for example, via the input unit 24.

The control unit 52 performs control to record the tape IDs of a part of the plurality of magnetic tape cartridges 16 belonging to the magnetic tape pool, on the RFID tags 17 provided in the plurality of magnetic tape cartridges 16. At this time, the control unit 52 performs control to record a plurality of different combinations of tape IDs on the respective RFID tags 17 provided in the plurality of magnetic tape cartridges 16.

Specifically, the control unit 52 performs the following control, in a case where a magnetic tape cartridge 16 of a tape ID received by the reception unit 50 is added to a magnetic tape pool of a pool ID received by the reception unit 50. In this case, the control unit 52 performs control to record the tape IDs of a part of a magnetic tape group already belonging to the magnetic tape pool, on an RFID tag 17 provided in a new magnetic tape cartridge 16 to be added to the magnetic tape pool. More specifically, the control unit 52 refers to the pool management table 32 to perform control to record the tape IDs of a predetermined first number H1 of magnetic tape cartridges 16 which are added most recently, on the RFID tag 17 of the new magnetic tape cartridge 16 to be added to the magnetic tape pool.

An example in which a magnetic tape cartridge 16 having a tape ID of “TapeD” is added to a magnetic tape pool having a pool ID of “PoolA”, to which three magnetic tape cartridges 16 having tape IDs of “TapeA”, “TapeB”, and “TapeC” already belong, will be described with reference to FIG. 7. In this example, the number H1 is two. In addition, the number in parentheses on the right such as “TapeA” in FIG. 7 indicates the addition order represented by the addition order information. As shown in FIG. 7, in this case, the tape identification information 38 including “TapeB” and “TapeC”, which are the tape IDs of two magnetic tape cartridges 16 having addition order of “2” and “3”, respectively, is recorded on the RFID tag 17 of the magnetic tape cartridge 16 having the tape ID of “TapeD”.

Further, the control unit 52 performs the following control, for a magnetic tape cartridge 16 (hereinafter, referred to as a “first magnetic tape cartridge”) in which the number of magnetic tape cartridges 16 already belonging to the magnetic tape pool when a new magnetic tape cartridge 16 is added to the magnetic tape pool is less than the number H1. In this case, first, the control unit 52 performs control to record the tape IDs of all the magnetic tape cartridges 16 already belonging to the magnetic tape pool when the first magnetic tape cartridge is added, on the RFID tag 17 of the first magnetic tape cartridge. Further, the control unit 52 performs control to record the tape ID of the magnetic tape cartridge 16 last added to the magnetic tape pool, by a number insufficient for the number H1, on the RFID tag 17 of the first magnetic tape cartridge at a predetermined timing T1.

Further, in a case where a new magnetic tape cartridge 16 is added to the magnetic tape pool, the control unit 52 performs control to record the pool ID of the magnetic tape pool on the RFID tag 17 of the magnetic tape cartridge 16.

Further, the control unit 52 performs control to record the tape IDs of a part of a group of magnetic tape cartridges 16 added to the magnetic tape pool after the magnetic tape cartridge 16, on the RFID tag 17 of each magnetic tape cartridge 16 belonging to the magnetic tape pool, at a predetermined timing T2. Specifically, the control unit 52 refers to the pool management table 32 to perform control to record the tape IDs of a predetermined second number H2 of magnetic tape cartridges 16 which are added immediately after each magnetic tape cartridge 16 belonging to the magnetic tape pool, on the RFID tag 17 of the magnetic tape cartridge 16 belonging to the magnetic tape pool.

An example in which the tape identification information 38 of “TapeB” of a magnetic tape pool having a pool ID of “PoolA”, to which four magnetic tape cartridges 16 having tape IDs of “TapeA”, “TapeB”, “TapeC”, and “TapeD” belong, is updated will be described with reference to FIG. 8. In this example, the number H2 is two. In addition, the number in parentheses on the right such as “TapeA” in FIG. 8 indicates the addition order represented by the addition order information. As shown in FIG. 8, in this case, “TapeA”, which is a tape ID of a magnetic tape cartridge 16 having addition order of “1” when the magnetic tape cartridge 16 is added to the magnetic tape pool, is recorded on the RFID tag 17 of the magnetic tape cartridge 16 having the tape ID of “TapeB”.

Further, in this case, “TapeC” and “TapeD”, which are tape IDs of two magnetic tape cartridges 16 having addition order of “3” and “4”, respectively, are recorded on the RFID tag 17 of the magnetic tape cartridge 16 having the tape ID of “TapeB” at the predetermined timing T2.

Further, the control unit 52 performs the following control, for a magnetic tape cartridge 16 (hereinafter, referred to as a “second magnetic tape cartridge”) in which the number of magnetic tape cartridges 16 added to the magnetic tape pool afterward is less than the number H2. In this case, first, the control unit 52 performs control to record the tape IDs of all the magnetic tape cartridges 16 added to the magnetic tape pool after the second magnetic tape cartridge, on the RFID tag 17 of the second magnetic tape cartridge. Further, the control unit 52 performs control to record the tape ID of a magnetic tape cartridge 16 first added to the magnetic tape pool, by a number insufficient for the number H2, on the RFID tag 17 of the second magnetic tape cartridge.

Examples of the predetermined timing T1 and timing T2 include timing of performing maintenance work on the recording and reproducing system 10, periodic timing, and timing of adding a magnetic tape cartridge 16 to the magnetic tape pool. In the present embodiment, a case where the timing T1 and the timing T2 have the same timing will be described, but the present disclosure is not limited thereto. The timing T1 and the timing T2 may be different from each other.

In the present embodiment, the number H1 and the number H2 are preset, according to a value V1 indicating whether the identification information of all the magnetic tape cartridges 16 belonging to the magnetic tape pool can be grasped even in a case where some magnetic tape cartridges 16, out of the plurality of magnetic tape cartridges 16 belonging to the magnetic tape pool, are missing.

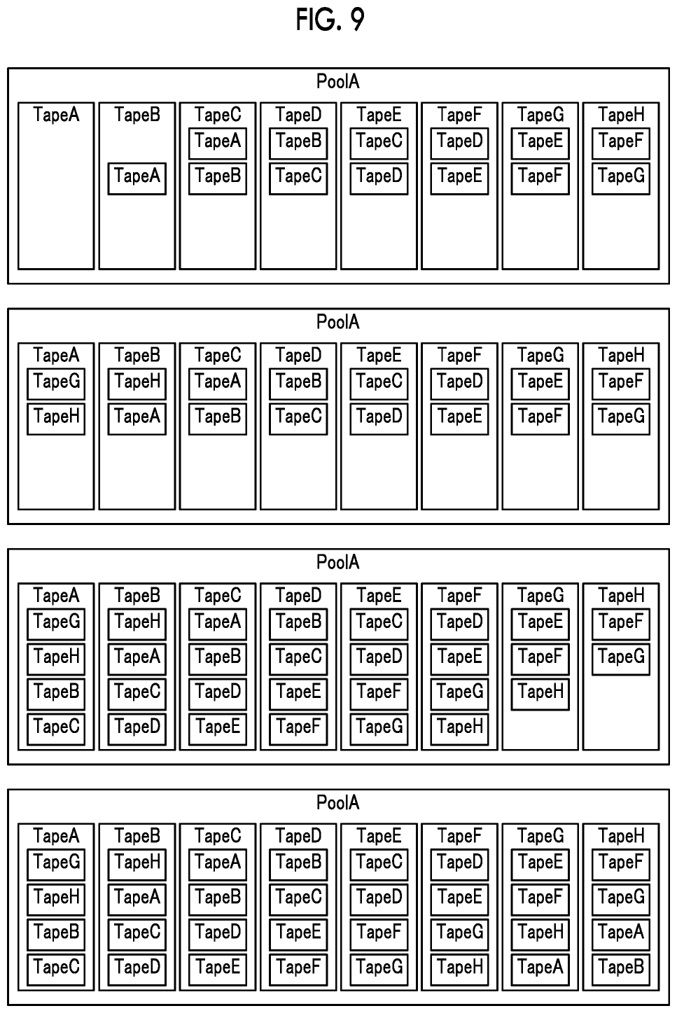

A specific example of the tape ID recorded on the RFID tag 17 of each magnetic tape cartridge 16 by the control performed by the control unit 52 will be described with reference to FIG. 9. FIG. 9 shows an example in which eight magnetic tape cartridges 16 having tape IDs of “TapeA” to “TapeH” belong to a magnetic tape pool having a pool ID of “PoolA”. In addition, FIG. 9 shows the tape ID recorded on the RFID tag 17 of each magnetic tape cartridge 16. Further, in FIG. 9, it is assumed that the alphabetical order of the last digit of the tape ID is equal to the addition order of the magnetic tape cartridge 16 to the magnetic tape pool.

Further, FIG. 9 shows an example in which the tape IDs of all the magnetic tape cartridges 16 belonging to the magnetic tape pool can be grasped even in a case where four magnetic tape cartridges 16, out of the eight magnetic tape cartridges 16 belonging to the magnetic tape pool, are missing. Further, FIG. 9 shows an example in which the number H1 and the number H2 are each preset to two according to the value V1.

As shown in the first column of FIG. 9, in a case where a magnetic tape cartridge 16 is added to the magnetic tape pool, the tape IDs of the most recent two magnetic tape cartridges 16 added before the magnetic tape cartridge 16 to be added are recorded on the RFID tag 17 of each magnetic tape cartridge 16. At this time, “TapeA” is recorded on the RFID tag 17, for “TapeB” in which the number of magnetic tape cartridges 16 already belonging to the magnetic tape pool when “TapeB” itself is added to the magnetic tape pool is less than two.

Further, as shown in the second column of FIG. 9, for “TapeA” and “TapeB”, the tape ID of a magnetic tape cartridge 16 last added to the magnetic tape pool is recorded, by a number insufficient for two, on the respective RFID tags 17 at the timing T1. That is, the last two “TapeG” and “TapeH” are recorded on the RFID tag 17 of “TapeA”, and the last one “TapeH” is recorded on the RFID tag 17 of “TapeB”.

As shown in the third column of FIG. 9, the tape IDs of two magnetic tape cartridges 16 added immediately after each magnetic tape cartridge 16 belonging to the magnetic tape pool are recorded on the RFID tag 17 of the magnetic tape cartridge 16 belonging to the magnetic tape pool, at the timing T2. At this time, “TapeH” is recorded on the RFID tag 17, for “TapeG” in which the number of magnetic tape cartridges 16 added to the magnetic tape pool after “TapeG” itself is less than two.

Further, as shown in the fourth column of FIG. 9, for “TapeG” and “TapeH”, the tape ID of a magnetic tape cartridge 16 first added to the magnetic tape pool is recorded, by a number insufficient for two, on the respective RFID tags 17. That is, the first two “TapeA” and “TapeB” are recorded on the RFID tag 17 of “TapeH”, and the first one “TapeA” is recorded on the RFID tag 17 of “TapeG”.

Therefore, the tape IDs of all the magnetic tape cartridges 16 belonging to the magnetic tape pool can be grasped from the tape IDs and the pool ID recorded on the RFID tags 17 of the remaining four magnetic tape cartridges 16, for example, no matter which combination of the four magnetic tape cartridges 16 is missing.

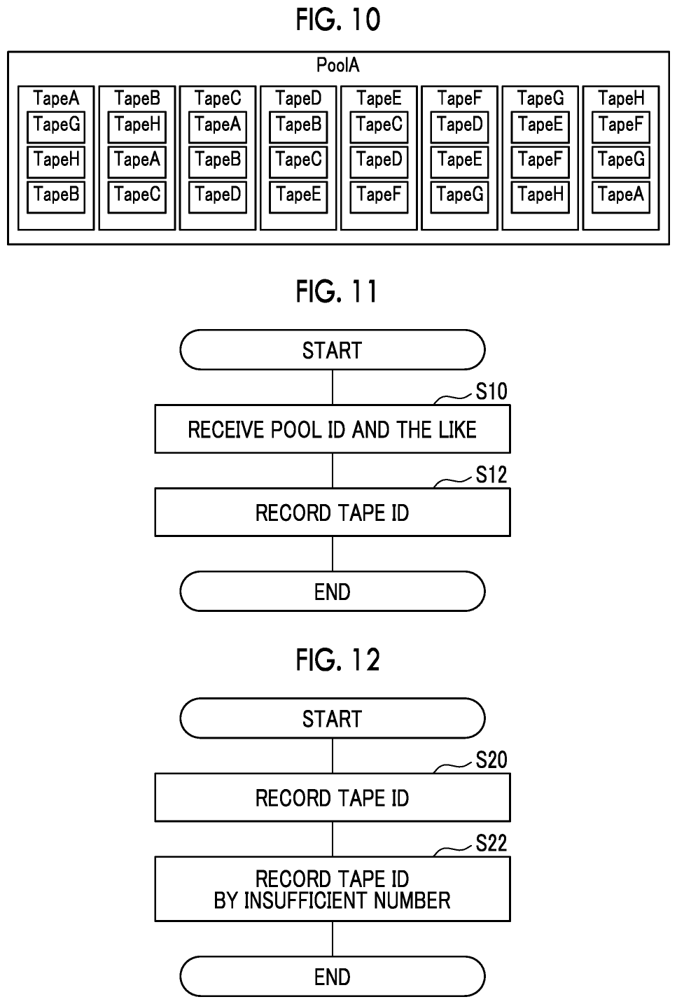

FIG. 10 shows an example in which the tape IDs of all the magnetic tape cartridges 16 belonging to the magnetic tape pool can be grasped even in a case where three magnetic tape cartridges 16, out of the eight magnetic tape cartridges 16 belonging to the magnetic tape pool, are missing. FIG. 10 shows an example in which the number H1 is preset to two and the number H2 is preset to one, according to the value V1. In this example, the tape IDs of all the magnetic tape cartridges 16 belonging to the magnetic tape pool can be grasped from the tape IDs and the pool ID recorded on the RFID tags 17 of the remaining five magnetic tape cartridges 16, no matter which combination of the three magnetic tape cartridges 16 is missing.

Next, an action of the information processing device 12 according to the present embodiment will be described with reference to FIGS. 11 and 12. The CPU 20 executes the information processing program 30, whereby first identification information recording processing shown in FIG. 11 and second identification information recording processing shown in FIG. 12 are executed. The first identification information recording processing shown in FIG. 11 is executed, for example, in a case where a pool ID of a magnetic tape pool to which a magnetic tape cartridge 16 is added and a tape ID of a new magnetic tape cartridge 16 to be added to the magnetic tape pool are input by the user via the input unit 24. Further, the second identification information recording processing shown in FIG. 12 is executed in a case where an execution instruction is input by the user via the input unit 24.

In step S10 of FIG. 11, the reception unit 50 receives the pool ID of the magnetic tape pool to which the magnetic tape cartridge 16 is added and the tape ID of the new magnetic tape cartridge 16 to be added to the magnetic tape pool.

In step S12, as described above, the control unit 52 refers to the pool management table 32 to perform control to record the tape IDs of a predetermined number H1 of magnetic tape cartridges 16 which are most recently added, on the RFID tag 17 of the new magnetic tape cartridge 16 to be added to the magnetic tape pool. At this time, the control unit 52 performs the following control, for the magnetic tape cartridge 16 (the above-described first magnetic tape cartridge) in which the number of magnetic tape cartridges 16 already belonging to the magnetic tape pool when the magnetic tape cartridge 16 is added is less than the number H1. In this case, the control unit 52 performs control to record the tape IDs of all the magnetic tape cartridges 16 already belonging to the magnetic tape pool when the first magnetic tape cartridge is added to the magnetic tape pool, on the RFID tag 17 of the first magnetic tape cartridge. In a case where the processing of step S12 ends, the first identification information recording processing ends.

In step S20 of FIG. 12, as described above, the control unit 52 refers to the pool management table 32 to perform control to record the tape IDs of a predetermined number H2 of magnetic tape cartridges 16 which are added immediately after each magnetic tape cartridge 16 belonging to the magnetic tape pool, on the RFID tag 17 of the magnetic tape cartridge 16 belonging to the magnetic tape pool. At this time, the control unit 52 performs the following control, for the magnetic tape cartridge 16 (the above-described second magnetic tape cartridge) in which the number of magnetic tape cartridges 16 added to the magnetic tape pool afterward is less than the number H2. In this case, first, the control unit 52 performs control to record the tape IDs of all the magnetic tape cartridges 16 added to the magnetic tape pool after the second magnetic tape cartridge, on the RFID tag 17 of the second magnetic tape cartridge. Further, the control unit 52 performs control to record the tape ID of a magnetic tape cartridge 16 first added to the magnetic tape pool, by a number insufficient for the number H2, on the RFID tag 17 of the second magnetic tape cartridge.

In step S22, as described above, the control unit 52 performs control to record the tape ID of the magnetic tape cartridge 16 last added to the magnetic tape pool, by a number insufficient for the number H1, for the RFID tag 17 on which the tape ID is recorded through the first identification information recording processing. In a case where the processing of step S22 ends, the second identification information recording processing ends.

As described above, according to the present embodiment, the management information of the magnetic tape pool to which the magnetic tape belongs can be recovered from the magnetic tape.

In the above-described embodiment, the control unit 52 may perform control to record the tape identification information 38 not on the RFID tag 17 but on, for example, the magnetic tape T.

Further, in the above-described embodiment, the control unit 52 may periodically perform control to record the tape ID on the RFID tag 17, for example, once a day. In this case, from the second and subsequent times, the control unit 52 may perform the control only in a case where the pool management table 32 is changed.

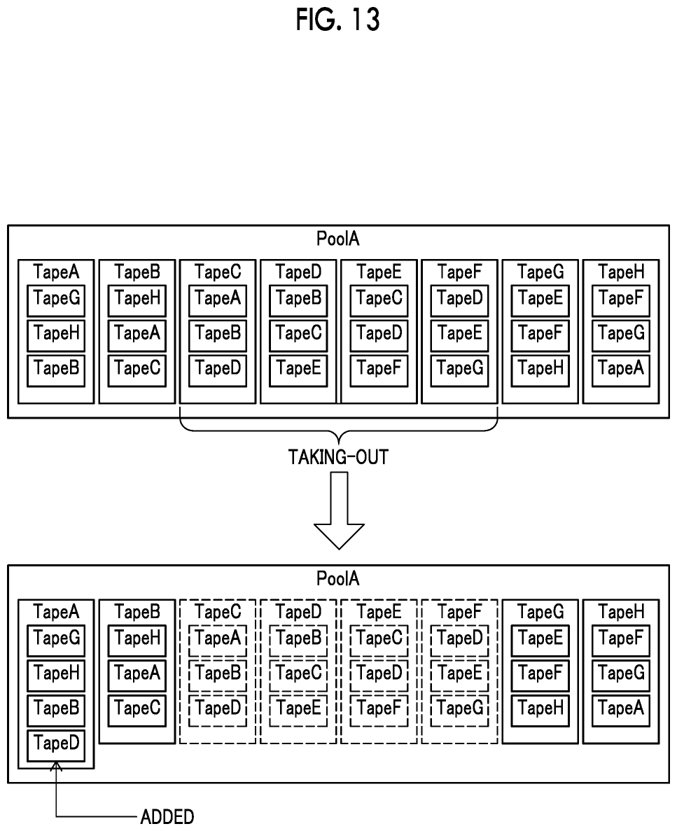

Further, in the above-described embodiment, as shown in FIG. 13, the control unit 52 may perform the following control, in a case where the number of magnetic tape cartridges 16 which exceeds a preset number (for example, the total value of the number H1 and the number H2), out of the plurality of magnetic tape cartridges 16 belonging to the magnetic tape pool, are taken out from the tape library 14. In this case, the control unit 52 may perform control to record the tape ID of the magnetic tape cartridge 16 that is taken out, on the RFID tag 17 of a magnetic tape cartridge 16 that is not taken out. In the example of FIG. 13, an example is shown in which four magnetic tape cartridges 16, out of eight magnetic tape cartridges 16, are taken out from the tape library 14. Further, in the example of FIG. 13, an example is shown in which only the tape ID that is not recorded on the RFID tag 17 of the magnetic tape cartridge 16 which is not taken out, out of the tape IDs of the magnetic tape cartridges 16 that are taken out, is recorded. Further, the magnetic tape cartridge 16 as the recording destination in this case is not particularly limited, and an aspect in which the tape ID is recorded on the RFID tag 17 of any one magnetic tape cartridge 16 is exemplified, as shown in FIG. 13. In the example of this aspect, the tape library 14 is an example of the storage unit according to the disclosed technique.

Further, in the above-described embodiment, the control unit 52 may perform control to record information regarding the magnetic tape cartridge 16 other than the tape ID, in addition to the tape ID. Examples of the information regarding the magnetic tape cartridge 16 includes information indicating the order in which the magnetic tape cartridge 16 is added to the magnetic tape pool.

Further, in the above-described embodiment, the control unit 52 may perform control to record the tape IDs of all the magnetic tape cartridges 16 belonging to the magnetic tape pool, on the respective RFID tags 17 of all the magnetic tape cartridges 16.

Further, in the above-described embodiment, for example, the following various processors can be used as the hardware structure of a processing unit that executes various kinds of processing, such as the reception unit 50 and the control unit 52. The above-described various processors include, for example, a programmable logic device (PLD) which is a processor having a changeable circuit configuration after manufacture, such as a field programmable gate array (FPGA), and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

Further, in the above-described embodiment, the aspect in which the information processing program 30 is stored (installed) in the storage unit 22 in advance has been described, but the present disclosure is not limited thereto. The information processing program 30 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 30 may be downloaded from an external device via a network.

The disclosure of JP2020-041408 filed on Mar. 10, 2020 is incorporated herein by reference in its entirety. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. An information processing device comprising:
at least one processor,
wherein the processor
performs control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

2. The information processing device according to claim 1,
wherein the processor performs, in a case where a new magnetic tape is added to the magnetic tape pool, control to record identification information of a predetermined first number of magnetic tapes of at least a part of a magnetic tape group already belonging to the magnetic tape pool, on the new magnetic tape or on the recording medium provided in a magnetic tape cartridge including the new magnetic tape.

3. The information processing device according to claim 2,
wherein the processor performs control to record identification information of a magnetic tape last added to the magnetic tape pool, by a number insufficient for the first number, on the new magnetic tape or on the recording medium provided in the magnetic tape cartridge including the new magnetic tape, in a case where the number of magnetic tapes already belonging to the magnetic tape pool is less than the first number.

4. The information processing device according to claim 1,
wherein the processor further performs, for the magnetic tape belonging to the magnetic tape pool, control to record identification information of a predetermined second number of magnetic tapes added to the magnetic tape pool after the magnetic tape belonging to the magnetic tape pool, at a predetermined timing.

5. The information processing device according to claim 4,
wherein the processor further performs control to record identification information of a magnetic tape first added to the magnetic tape pool, by a number insufficient for the second number, for a magnetic tape for which the number of magnetic tapes added to the magnetic tape pool afterward is less than the second number.

6. The information processing device according to claim 1,
wherein the processor periodically performs the control.

7. The information processing device according to claim 1,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

8. The information processing device according to claim 7,
wherein the processor performs, in a case where the number of the magnetic tapes which exceeds the preset number, out of the plurality of magnetic tapes belonging to the magnetic tape pool, are taken out from a storage unit in which the magnetic tapes are stored, control to record identification information of the magnetic tapes that are taken out, on a magnetic tape that is not taken out or on the recording medium provided in a magnetic tape cartridge including the magnetic tape that is not taken out.

9. The information processing device according to claim 1,
wherein the processor performs control to record information regarding the magnetic tape other than the identification information, in addition to the identification information of the magnetic tape.

10. The information processing device according to claim 9,
wherein the information regarding the magnetic tape is information indicating an order in which the magnetic tape is added to the magnetic tape pool.

11. The information processing device according to claim 2,
wherein the processor further performs, for the magnetic tape belonging to the magnetic tape pool, control to record identification information of a predetermined second number of magnetic tapes added to the magnetic tape pool after the magnetic tape belonging to the magnetic tape pool, at a predetermined timing.

12. The information processing device according to claim 3,
wherein the processor further performs, for the magnetic tape belonging to the magnetic tape pool, control to record identification information of a predetermined second number of magnetic tapes added to the magnetic tape pool after the magnetic tape belonging to the magnetic tape pool, at a predetermined timing.

13. The information processing device according to claim 2,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

14. The information processing device according to claim 3,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

15. The information processing device according to claim 4,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

16. The information processing device according to claim 5,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

17. The information processing device according to claim 6,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

18. The information processing device according to claim 11,
wherein the number of magnetic tapes of which the identification information is recorded on the magnetic tape or the recording medium is preset, according to a value indicating whether identification information of all the magnetic tapes belonging to the magnetic tape pool is capable of being grasped even in a case where some magnetic tapes, out of the plurality of magnetic tapes belonging to the magnetic tape pool, are missing.

19. An information processing method executed by a processor provided in an information processing device, the method comprising:
performing control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.

20. A non-transitory computer-readable storage medium storing an information processing program for causing a processor provided in an information processing device to execute a process comprising:
performing control to record identification information of at least a part of a plurality of magnetic tapes belonging to a magnetic tape pool, on the plurality of magnetic tapes or on a recording medium except for the magnetic tapes that is provided in a plurality of magnetic tape cartridges including the plurality of magnetic tapes, respectively.
